(19) United States
(12) Patent Application Publication
(10) Pub. No.: US 2019/0180326 A1
(43) Pub. Date: Jun. 13, 2019

(54) DETERMINING RELEVANT BUSINESS LOCATIONS BASED ON TRAVEL DISTANCES

(71) Applicant: Google LLC, Mountain View, CA (US)

(72) Inventors: Derek COATNEY, San Jose, CA (US); Eric L. LORENZO, Mountain View, CA (US); Yi ZHU, Mountain View, CA (US); Amin Charaniya, Mountain View, CA (US); Gaurav Ravindra BHAYA, Mountain View, CA (US); Gaurav Ravindra BHAYA, Sunnyvale, CA (US)

(73) Assignee: Google LLC, Mountain View, CA (US)

(21) Appl. No.: 16/279,557

(22) Filed: Feb. 19, 2019

Related U.S. Application Data
(63) Continuation of application No. 14/057,194, filed on Oct. 18, 2013.

(51) Int. Cl. G06Q 30/02

(52) U.S. Cl. CPC G06Q 30/0261

(57) ABSTRACT

Methods, systems, and apparatus include computer programs encoded on a computer-readable storage medium, including a method for providing content. A request for content is received from a user device. A content item is identified for delivery to the user device responsive to the request. A location of the user device is determined. A threshold distance is determined that a user is likely willing to travel when visiting a physical location associated with the content item or content sponsor. A bounding region associated with the location of the user device is identified. Location extensions are identified that are associated with the content item. A determination is made when one of the location extensions is included in the bounding region and when a distance between the location extension and a current location of the user is less than the determined threshold distance. The content item is augmented with the one location extension.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a computer-implemented method for providing content. The method includes receiving a request for content from a user device. The method further includes identifying, by one or more processors, a content item for delivery to the user device responsive to the request. The method further includes determining a location of the user device. The method further includes determining a threshold distance that a user is likely willing to travel when visiting a physical location associated with the content item or content sponsor. The method further includes identifying a bounding region associated with the location of the user device. The method further includes identifying one or more location extensions that are associated with the content item. The method further includes determining, by one or more processors, when one of the one or more location extensions is included in the bounding region and when a distance between the location extension and a current location of the user is less than the determined threshold distance. The method further includes augmenting, based on the determining when the distance is less than the determined threshold, the content item with the one location extension.

These and other implementations can each optionally include one or more of the following features. The request for content can be associated with a search query, a map request or page request. The user device can be a mobile device, and location information for the user can be provided as part of the request. Determining the threshold distance can include evaluating requests from plural users and determining the threshold distance as a mathematical function derived from the evaluating. Evaluating can include evaluating driving direction requests received from users that terminate at a location associated with the one location extension. The mathematical function can be a numeric average and the threshold distance can represent an average distance a user would drive to visit the location. The threshold distance can be determined based on a characterization associated with a sponsor of the content item. The characterization can be based on a type of product or service offered by the sponsor. Identifying one or more location extensions can include identifying plural location extensions that are included in the bounding region and selecting one of the plural regions. The selecting can be a random selection. Augmenting can include providing the one location extension for presentation in proximity to the content item when displayed on the user device. Identifying a bounding region can include: identifying a first bounding region; determining that no location extensions for the content item are included in the first bounding region; identifying, based on determining that no location extensions for the content item are included in the first bounding region, a second larger bounding region; determining when one of the one or more location extensions is included in the second larger bounding region; and augmenting the content item with the one location extension.

In general, another innovative aspect of the subject matter described in this specification can be implemented in computer program products that include a computer program product embodied in a non-transitive computer-readable medium including instructions, that when executed, cause one or more processors to: receive a request for content from a user device; identify a content item for delivery to the user device responsive to the request; determine a location of the user device; determine a threshold distance that a user is likely willing to travel when visiting a physical location associated with the content item or content sponsor; identify a bounding region associated with the location of the user device; identify one or more location extensions that are associated with the content item; determine when one of the one or more location extensions is included in the bounding region and when a distance between the location extension and a current location of the user is less than the determined threshold distance; and augment, based on the determining when the distance is less than the determined threshold, the content item with the one location extension.

These and other implementations can each optionally include one or more of the following features. The request for content can be associated with a search query, a map request or page request. The user device can be a mobile device, and location information for the user can be provided as part of the request. Determining the threshold distance can include evaluating requests from plural users and determining the threshold distance as a mathematical function derived from the evaluating. Evaluating can include evaluating driving direction requests received from users that terminate at a location associated with the one location extension. The mathematical function can be a numeric average and the threshold distance can represent an average distance a user would drive to visit the location. The threshold distance can be determined based on a characterization associated with a sponsor of the content item.

In general, another innovative aspect of the subject matter described in this specification can be implemented in systems, including a system comprising a content item engine for selecting one or more content items that are stored in a repository and that are responsive to one or more search queries or received requests; a location identifier engine for identifying one or more location identifiers indicative of a location for a particular user device that submits a search query; a distance threshold engine for determining a distance threshold associated with an entity or category of entities for the selected content items; and a location extension engine for using the received content items, the received distance threshold and the received location identifiers to generate one or more augmented content items.

Particular implementations may realize none, one or more of the following advantages. More relevant content items, locations, and/or, location extensions can be provided in response to receiving a request for information. Content items can be augmented based on a relative location of a user which also tends to provide more relevant content items, locations, and/or location extensions.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 is a block diagram of an example system for providing content to a user.

FIG. 3 is a flowchart of an example process for determining relevant business locations.

FIG. 4 is a block diagram of computing devices that may be used to implement the systems and methods described in this document, as either a client or as a server or plurality of servers.

Like reference numbers and designations in the various drawings indicate like elements.

### DETAILED DESCRIPTION

In general, the subject matter of this specification relates to determining when to add location information to one or content items to which the location information is associated. Some content items do not include location information, such as an address or other information that associates a particular physical location with the subject matter included in the content item. For various reasons, a content sponsor may desire to not specify a particular location for a give content item, such as an advertisement, making the content item location agnostic. For example, a ubiquitous business entity may desire to produce content that is relevant to be delivered to a wide audience that spans many different geographic areas. As such, specific location information may not be practical to be included in such distributions. However, if no specific location information is provided, the content item delivered may be ineffective. Using the techniques described herein, once a relevant content item is selected, location information can be added to the content item to generate an augmented content item based on a determination that location information should be or is desirable to be added to the content item.

In some implementations, the location information that is added to the content item is a location extension. In general, a location extension is location information that is associated with a particular physical instantiation of a presence associated with a content sponsor (i.e., a brick and mortar location for the entity). In some implementations, the location extension may include an address of the particular location and one or more user selectable links for the particular location. In one example, a user selectable map link may be included in the location extension such that when a user selects the map link, the map link causes an application executing on the user's device to present the particular location in the context of a surrounding area on a map.

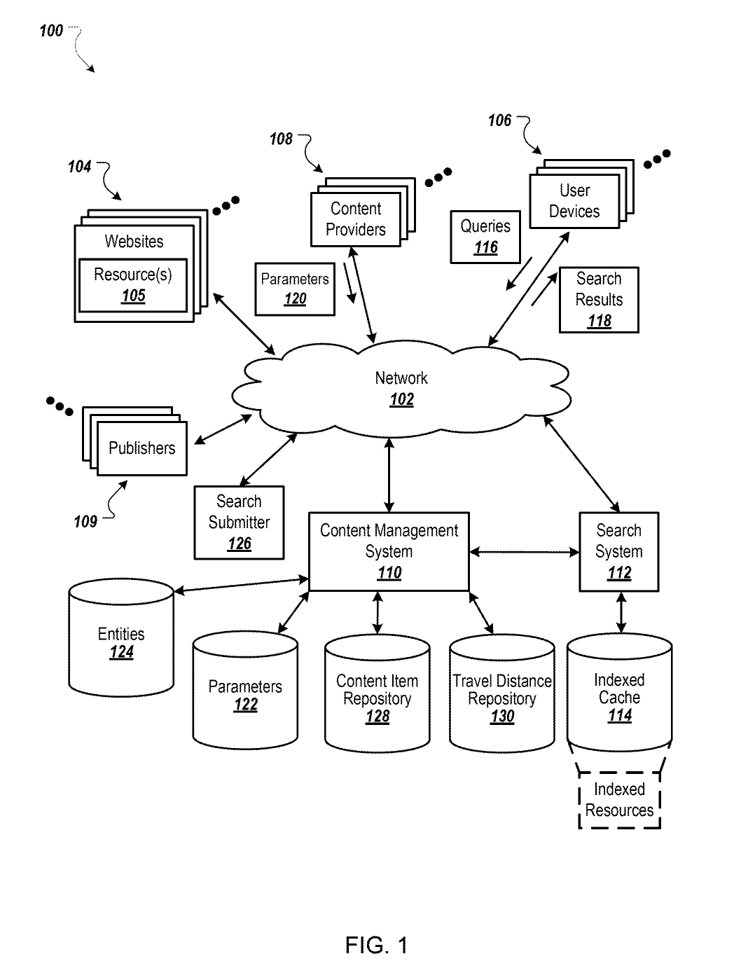

In general, the content items that are augmented with location information are responsive to a request for information. In some implementations, augmentation occurs after the content item has been selected for delivery, such as after having been selected as a winner of an auction. For example, a request for information may be “furniture stores in San Jose, Calif.” or “restaurants near the Monterey Bay Aquarium.” A system, for example, can be configured to determine one or more content items for furniture stores that can be provided in response to the system receiving the “furniture stores in San Jose, Calif.” request for information. One or more of the determined content items may have associated location information which can be used to augment a respective content item as will be described in greater detail below. Various techniques for identifying content items that are responsive to a request are described in association with FIG. 1.

FIG. 1 is a block diagram of an example environment 100 for providing content to a user. The example environment 100 includes a network 102 such as a local area network (LAN), wide area network (WAN), the Internet, or a combination thereof. The network 102 connects websites 104, user devices 106, content providers 108 (e.g., a content provider 108a and a content provider 108b), publishers 109, and a content management system 110. The example environment 100 may include many thousands of websites 104, user devices 106, content providers 108, and publishers 109.

A website 104 includes one or more resources 105 associated with a domain name and hosted by one or more servers. An example website 104 is a collection of webpages formatted in hypertext markup language (HTML) that can contain text, images, multimedia content, and programming elements, e.g., scripts. Each website 104 is maintained by, for example, a publisher 109, e.g., an entity that controls, manages and/or owns the website 104.

A resource 105 is any data that can be provided over the network 102. A resource 105 is identified by a resource address that is associated with the resource 105. Resources 105 include HTML pages, word processing documents, and portable document format (PDF) documents, images, video, and feed sources, to name only a few examples. The resources 105 can include content, e.g., words, phrases, images and sounds that may include embedded information (such as meta-information in hyperlinks) and/or embedded instructions (such as scripts).

To facilitate searching of resources 105, the environment 100 can include a search system 112 that identifies the resources 105, for example, by crawling and indexing the resources 105 provided by the publishers 109 on the websites 104. In some implementations, data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices, tablet devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can, for example, access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

In some implementations, slots on search results pages or other webpages can include content slots for content items that have been provided as part of a reservation process. In a reservation process, a publisher and a content item sponsor enter into an agreement where the publisher agrees to publish a given content item in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. A request for a resource 105 or a search query 116 can also include an identifier, such as a cookie, identifying the requesting user device 106 (e.g., in instances in which the user consents in advance to the use of such an identifier).

Based, for example, on data included in the request for content, the content management system 110 can select content items that are eligible to be provided in response to the request, such as content items having characteristics (e.g., selection criteria) matching the characteristics of a given slot. As another example, content items having selection criteria (e.g., keywords) that match the resource keywords or the search query 116 may be selected as eligible content items by the content management system 110. One or more selected content items can be provided to the user device 106 in association with providing an associated resource 105 or search results 118.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

In some implementations, some content providers 108 prefer that the number of impressions allocated to their content and the price paid for the number of impressions be more predictable than the predictability provided by an auction. For example, a content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define the content campaign. The content campaign can be created and activated for the content provider 108 according to the parameters 120 specified by the content provider 108. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., creatives), and selection criteria. Selection criteria, a language, one or more geographical locations or websites, and/or one or more selection terms (e.g., keywords).

In the proposed examples, the content management system 110 can use selection criteria when evaluating received requests for content. For example, a search query 116 that includes one or more terms can be received by a computer system. The content management system 110 can compare request terms to selection criteria associated with a content item. The content management system 110 can determine that a match exists between a content request and a content item. The content management system 110 can select the content item for presentation responsive to the content request and can provide the selected content item to the requesting user device 106. Other examples are possible, such as described in more detail below.

In some implementations, information pertaining to one or more content items may be stored in a content items repository 128. The content items repository 128 may be any data store that is suitable for storing relationships between one or more contents items, one or more keywords, location information, and combinations of these.

In some implementations, the content item repository 128 can store information that pertains to one or more content items that correspond to a specific area, theme, or product for a particular content sponsor (e.g., such as a car manufacturer). In some implementations, the content sponsor can be a content provider. A content item stored in the content item repository 128 can be associated with one or more campaigns. For example, a particular advertising campaign may have one or more different targets (e.g., such as a demographic group) and one or more adgroups of content items that are directed to at least some of the targets. In a particular example, a car manufacturer may wish to provide content items related to a car's safety to a parental demographic and may wish to provide content items related to a car's performance or physical characteristics to a different demographic based at least in part on keywords or terms that corresponding to entities received in a search query 116. In some implementations, an entry in the content item repository 128 is of the form of an adgroup which may have a particular adgroup id that differentiates one adgroup from another adgroup in the content item repository 128.

In general, some or all of the information associated with the content items in the content item repository 128 is provided by the content sponsor when the content sponsor generates the one or more campaigns. For example, the content sponsor can provide one or more location extensions for venues to be associated with particular ones of the sponsor's content items. In some implementations, the particular location extensions to be associated with the content items are based on a particular campaign. For example, some fast food restaurants include kid play areas. Location extensions for those venues can be associated with content items for more kid friendly promotions while location extensions that do not include kid play area can be associated with content items for less kid friendly promotions, such as promotions for a drive through being open past midnight.

In some implementations, the environment 100 may include a travel distance repository 130. The travel distance repository 130 may store travel distances by one or more user to physical locations or categories of physical locations. For example, the travel distance repository 130 can store information pertaining to how far one or more users typically (or are willing to) travel when visiting/making purchases at a particular retailer or particular class of retailer. For example, an average distance one would travel to go to a coffee shop can be stored in the travel distance repository. The distance can be an average distance, or another predetermined distance based on interactions users with or in association with a particular entity or a class of entities. The distance can be a straight-line distance, a driving distance, walking distance, or other measured distance. Alternatively, the distance can be represented by an amount of time that would be required to travel given transportation type, road conditions, weather and other factors. In some implementations the distance information can be inferred over time or otherwise learned as users interact with content (and the system learns of subsequent interactions or not) after presentation of a given content item.

The travel distance repository 130 may be any data store that is suitable for storing relationships between specific entities, general entities or types of entities and a respective assigned distance. As used herein entity refers to a named business/service or type of business or service. Entities can also represent, for example, a person (e.g., celebrity, president), place (e.g., national park, city), thing (e.g., ice cream, sweater), or concept (e.g., biology, motherhood)). Other examples of entities include a product, service, organization, vertical, or abstract idea. In some implementations, the travel distance repository 130 can be a relational database. In some implementations, the travel distance repository 130 may also store average distances for all users of the environment 100 for particular modes of transportation and/or types of business entity. For example, the content management system 110 (or other system or component in the environment 100) can periodically access the travel distance repository 130 to determine relevant distance information for use in determining when to augment a content item with location extension information. The augmentation of content items is discussed in greater detail below. In some implementations, the content management system 110 can compute an average travel distance for the particular entity based on travel distances associated with a plurality of entities of the same type or category. The determined average travel distance can be stored in the travel distance repository 130 and may be combined with or supplemented by additional travel distance determinations over-time. As a result, the travel distance repository 130 can maintain an updated representation of travel distances for one or more modes of transportation and to multiple particular entities or category of entities.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

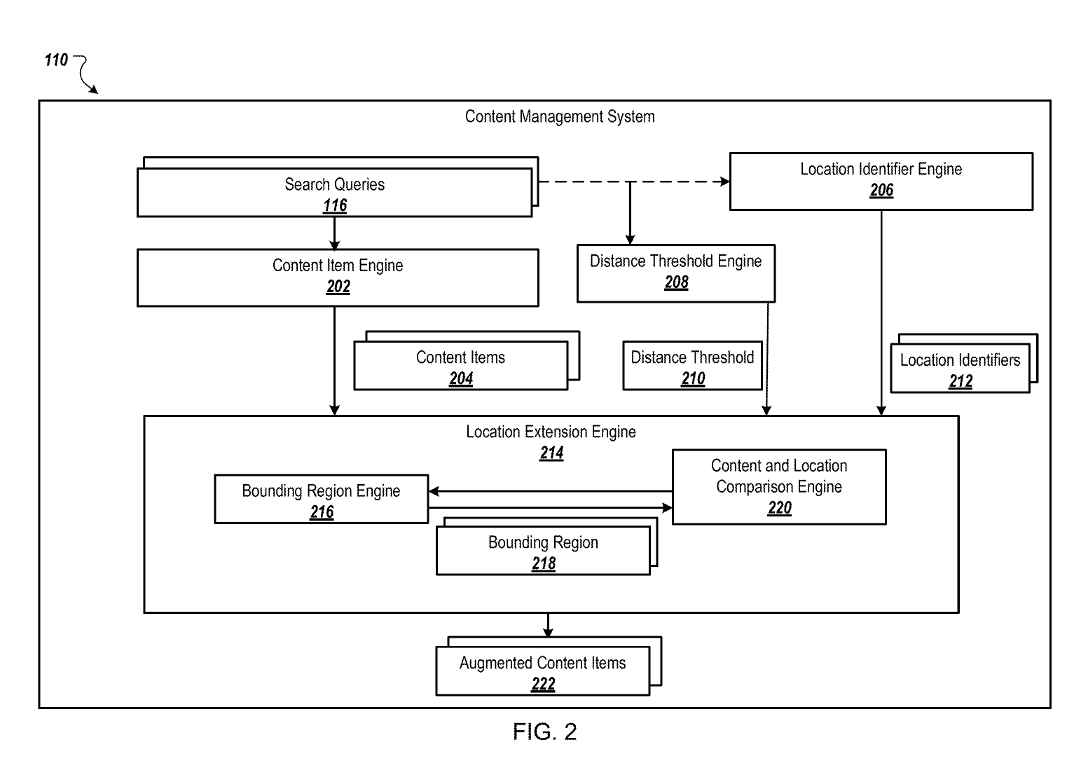

FIG. 2 is a block diagram of an example content management system 110 (FIG. 1). As described above, the content management system 110 can provide one or more content items in response to requests for content. The content management system 110 may augment one or more content items with location information. In general, the content management system 110 can augment one or more content items that are associated with a particular location or venue. In a particular example, augmentation occurs when a particular location or venue associated with a content item that has been selected to be delivered is determined by the content management system 110 to be located within a predetermined distance of the current location of the requestor. The predetermined distance can be based on a threshold, such as an average travel distance for multiple users traveling to a similar entity or category of entity. In general, the augmented content items can be used to improve the overall user experience, e.g., by providing a user selectable link that presents a particular location in a context of a map and surrounding locations. As a result, a user may be more willing to interact with a content item or to visit the particular location as the user is provided with an indication of where the particular location is situated and how to navigate to the particular location.

The example content management system 110 is shown with a number of different components. These components enable the content management system 110 to add location information to one or more content items. The content management system 110 includes a content item engine 202, a location identifier engine 206, a distance threshold engine 208, and a location extension engine 214.

In general, the content management system 110 can receive one or more search queries 116 (so as to be able to provide one or more additional content items for presentation along with search results) or other requests for content (such as to fill a slot on a resource) as described above. For example, the content management system 100 can receive a request for “furniture stores in San Jose, Calif.” or “restaurants near the Monterey Bay Aquarium.” The one or more search queries 116 can be provided to a combination of a content item engine 202, a distance threshold engine 208, and optionally to a location identifier engine 206.

The content item engine 202 can select or otherwise identify one or more content items 204 that are stored in a repository (e.g., content items deposits 128 (FIG. 1)) and that are responsive to the one or more search queries 116 or received requests. The one or more identified (i.e., eligible) content items 204 can be provided to a selection service, such as associated with an auction or reservation process to determine particular ones of the eligible content items that are to be delivered responsive to the received requests. Depending on the processing by the location extension engine 214, one or more of these particular ones (i.e., the selected ones) of the content items can be augmented with location information as will be described in greater detail below.

The location identifier engine 206 can be configured to identify one or more location identifiers 212 indicative of a location for a particular user device that submits a search query 116. In general, a location identifier 212 can include a state, city with the state, and area with the city, or other information that is indicative of a location for the particular user device (e.g., a longitude and latitude) and that can be used to describe a location of the user device. For example, the location identifier engine 206 can use internet protocol (IP) based geo-location using an IP address of a user device that submitted the search query 116 to determine one or more location identifiers 212 that describe the location of the user device. As another example, the location identifier engine 206 can use global position system (GPS) information to determine one or more location identifiers 212 that describe the location of the user device. As yet another example, the content management system 110 can receive cellular tower triangulation data or other data to determine one or more location identifiers 212 that describe the location of the user requesting device.

In some implementations, the search queries 116 may include one or more terms that are indicative of a location. For example, the request “furniture stores in San Jose, Calif.” includes the terms “San Jose” and “CA” (or the keyword phrase “San Jose, Calif.”) and may indicate a general geographic location of the San Jose, Calif. metropolitan area. As another example, the request “restaurants near the Monterey Bay Aquarium” includes the terms “Monterey,” “Bay,” and “Aquarium” (or the keyword phrase “Monterey Bay Aquarium”) that indicates a location nearby the Monterey Bay Aquarium. The content management system 110 can determine when one or more of the terms in a search query 116 are indicative of a location of the user device. For example, the content management system 110 can use parsing techniques, string comparison techniques, or other techniques to match one or more terms in a search query 116 with one or more stored location identifiers 212 or other indicators of location that can be used to determine the one or more location identifiers 212. Other techniques for determine the location identifiers 212 are also possible. The location identifiers 212 can be provided to the location extension engine 214.

The distance threshold engine 208 can determine a distance threshold 210 associated with an entity or category of entities for the selected content items. In some implementations, the distance threshold engine 208 can determine a distance threshold for a category of entities. For example, the search query “furniture stores in San Jose, Calif.” can be used by the distance threshold engine 208 to determine a distance threshold 210 for a category of entities that can be described as “furniture stores.” In general, the distance threshold engine 208 can access the travel distance repository 130 (FIG. 1) when determining a distance threshold 210. For example, the distance threshold engine 208 can access the travel distance repository 130 and access a predetermined average travel distance for a determined mode of transportation for a particular entity or category of entities. As another example, the distance threshold engine 208 can determine an average travel distance for the determined mode of transportation for the particular category of entity based on the travel distances in the travel distance repository 130 for the particular entity and one or more similar entities, as described elsewhere in this specification. The determined distance threshold 210 can be provided to the location extension engine 214.

In some implementations, the mode of transportation can be determined based on a number of factors. For example, changes in position over time can be used to determine the speed at which the user device is moving. In a particular example, a determined speed of one to three miles per hour may be indicative of a walking mode of transportation while a determined speed of greater than thirty miles per hour may be indicative of a driving mode of transportation. As another example, information in a user profile may be indicative of a mode of transportation. In this particular example, the user profile may include information that shows a history of driving at certain times of day and walking during other times of day. As another example the search query 116 may include hints that can be used to determine a mode of transportation. For example, the search query may include terms like “walking,” “biking,” “driving,” and so forth that are indicative of a mode of transportation. As another example, the search query 116 may be received along with a preferred mode of transportation. Other techniques for determining a transportation mode are also possible.

The location extension engine 214 can use the received content items 204, the received distance threshold 210, and the received location identifiers 212 to generate one or more augmented content items 222. For example, the location extension engine 214 can add location extensions to content items that are associated with physical locations that are determined to be within a distance of the user device that is less than or equal to the distance threshold 210. That is, if the distance to a particular physical location or venue is greater than the distance threshold, the content management system 110 may not augment the content item. The location extension engine 214 includes one or more components that can be used to generate augmented content items 222. In the depicted example, the location extension engine 214 includes a bounding region engine 216 and a content and location comparison engine 220, although other components can be also be used to generate one or more augmented content items 222.

The bounding region engine 216 can generate one or more bounding regions 218, such as a bounding box, a bounding circle, or other bounding shape. The one or more bounding regions 218 can be used to delineate an area for evaluation. For example, the bounding region engine 216 may generate a first one of the one or more bounding regions 218 based on some combination of the received location identifiers 206 and the distance threshold 210. In this particular example, a bounding region can be determined to correspond to the distance threshold 210 generally centered at the location of the user device specified by the location identifiers 212. As another example, the bounding region engine 216 can generate one or more bounding regions based on the location of the user device (e.g., as specified by the location identifiers 212). In this particular example, the bounding region engine 216 can generate a bounding that has a determined location of the user device as the center of the one or more bounding regions 218. The first one of the one or more bounding regions 218 can then be provided to a content and location comparison engine 220.

The content and location comparison engine 220 can identify one or more location extensions that are associated with selected one or more content items 204 to determine one or more suitable content items 222 that can be eligible for augmentation. For example, the content and location comparison engine 220 can compare some combination of a first one of the one or more bounding regions 218, the location identifiers 206, and locations extension associated with the one or more content items 204 to determine when one or more of the locations associated with a respective location extension is included in the first of the one or more bounding regions 218. For example, the content and location comparison engine 220 can compare a particular location extension that is associated with a particular one of the one or more content items 204 with the one or more bounding regions 218 to determine when the particular location is within the one or more bounding regions 218.

When, for example, the content and location comparison engine 220 determines that a location associated with a location extension is within the one or more bounding regions 218, the content and location comparison engine 220 can augment the content item 204. When, for example, the content and location comparison engine 220 determines that a location extension is not within the one or more bounding regions 218, no initial augmentation may occur. A list of one or more augmented or otherwise non-augments content items can be maintained and ultimately delivered to a user responsive to a received request.

In some implementations, when no augmented content items are identified for presentation in association with one or more bounding regions 218, a second different bounding region may be constructed. For example, the bounding region engine 216 may generate a second one of the one or more bounding regions 218 that is larger in area relative to the first one of the one or more bounding regions 218. In a particular example, the second one of the one or more bounding regions 218 may be forty-kilometers by forty-kilometers larger than the first one of the one or more bounding regions 218.

The bounding region engine 216 may provide the second one of the one or more bounding regions 218 to the content and location comparison engine 220 to identify one or more location extensions that are associated with one or more content items 204, as described elsewhere above. For example, the content and location comparison engine 220 can compare location information included in a particular location extension that is associated with a particular one of the one or more content items 204 with the second one of the one or more bounding regions 218 to determine when the particular location extension is within the second one of the one or more bounding regions 218. In this example, the location extension engine 214 can be configured to perform an iterative process to gradually increase the one or more bounding regions 218 until a number of bounding regions have been generated (e.g., until two bounding regions have been generated). In some implementations, no augmentation will occur if no suitable location extensions are located in the second bounding region. In some implementations, additional larger bounding regions can be created and the process repeated.

The content management system 110 can augment one or more content items to generate the augmented content items 222. For example, a particular content item can be modified so that an address associated with a location of a content sponsor associated with the particular content item is presented near or next to the particular content item. As another example, a particular content item in a list of suitable content items 222 can be modified so that a user selectable link is presented near or next to the particular content item. The selectable link, for example, can be responsive to user input causing an application to present a map that includes a location of a content sponsor that corresponds to the selectable link in a context of a surrounding area.

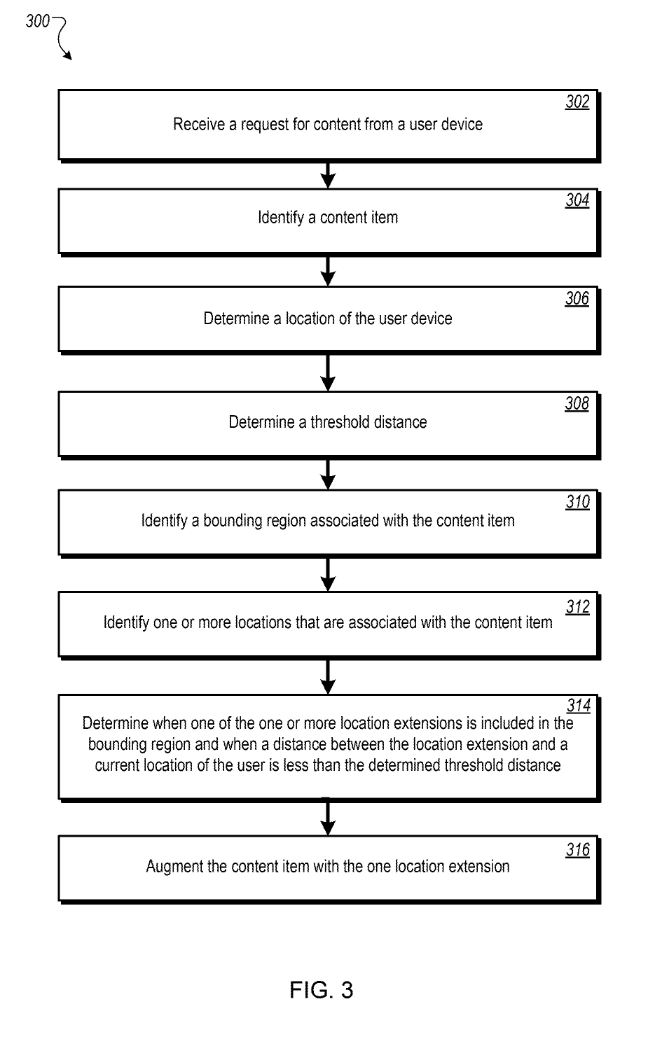

FIG. 3 is a flowchart of an example process 300 for determining relevant business locations. The process 300 can be performed, for example by the content management system 100 and associated components described above with respect to FIGS. 1 and 2. Other systems and components may be configured to perform or assist in the process 300. In general, the process 300 determines relevant (e.g., business) locations that can be used to augment one or more content items that have been determined to be delivered responsive to a received request. Augmentation can occur when a selected content item is within a pre-determined bounding area and/or less than a threshold distance from a location associated with a user device (e.g., submitting a request for information).

In operation, a request for content from a user device is received (302). For example a content management system 110 (FIG. 1) can receive a request for information. In general, the request includes one or more terms. In some implementations, the request can be of the form of a search query, a map request, or a page request. For example, a search query may include the terms “furniture stores San Jose.” As another example, a map request may include the terms “Starbucks near El Camino Real in Jose, Calif.” In some implementations, the search query and the map request can be substantially similar but may be provided to a search engine or a map engine, respectively. For example, the search engine may present one or more search results response to the request while the map engine may present a map of an area determined to include on or more locations responsive to the request.

A content item for delivery to the user device responsive to the request is identified (304). For example, the content management system 110 (FIG. 1) can access a content item repository 128 (FIG. 1) and perform one or more content selection techniques including matching one or more keywords included in the request with one or more keywords associated with one or more content items in the content item repository 128 to identify one or more content items that are responsive to the request. The content management system 100 may also perform an auction or other technique to limit or otherwise filter the number of identified content items to determine one or more selected content items that will be delivered responsive to the request.

A location of the user device is determined (306). For example, the content management system 110 (FIG. 1) can use IP based geo-location using an IP address of a user device that submitted the request for content to determine the location, or likely location, of the user device. As another example, the content management system can use GPS information to determine the location, or likely location, of the user device. As yet another example, triangulation information (e.g., by using multiple cellular towers) obtained by a network provider for the user device can be used to determine a location of the user device. Combinations of approaches can also be used to verify a location of the user device. For example, a geo-location using an IP address can be combined with GPS information to verify the location of the user device. As another example, the request for content can be used to verify the location of the user device. For example, if the request for content is a search string for “restaurants near the Monterey Bay Aquarium” and the GPS signal indicates that the user is located Anchorage, Alaska, the GPS signal may not be a true indication of the user's position. Although, in general, a difference in position indicated by the request for content and GPS information or other information indicative of a location of the user device may cause the content management system 110 to forgo any augmentation any of the content items, as a determined distance between the user device and one or more location extensions will likely be greater than a travel distance threshold, as described elsewhere in this specification.

A distance threshold that a user is likely willing to travel when visiting a physical location associated with the content item or content sponsor is determined (308). For example, the content management system 110 (FIG. 1) can access a travel distance repository 130 (FIG. 1) that includes average travel distances to multiple entities or category of entities including a category of entities similar to the entity associated with the selected content item or content sponsor. Such an average distance may be indicative of a distance that the particular user is willing to travel when visiting the physical location. Other techniques may also be used, e.g., weighting different travel distances in the travel distance repository 130 based on shared characteristics of one or more user profiles for one or more users. For example, if a first user has a preferred mode of transportation (e.g., biking), the first user may be more willing to travel a farther distance using the preferred mode of transportation than a second user that has a different preferred mode of transportation (e.g., driving) but has nevertheless traveled to a particular location using the preferred mode of transportation of the first user. In such examples, the travel distance associated with the second user using the biking mode of transportation (or other preferred mode of transportation) may be weighted less than the travel distance of other users that share a biking preferred mode of transportation when determining an average travel distance.

In some implementations, the determining the threshold distance includes evaluating requests from plural users and determining the threshold distance as a function or model derived from evaluating the requests. One example is performing an averaging operation on multiple travel distances stored in the travel distance repository 130 (FIG. 1), although other mathematical operations can also be performed.

In some implementations, evaluating function includes evaluating a direction request from the plural users that terminate at a location associated with the one location extension. For example, multiple users may request driving directions, walking directions, and so forth for a particular location. Some of those users may change the driving directions to deviate from an optimal path (e.g., based on time to destination, reduce the distance to the destination, or optimize other aspects of the travel) to avoid traffic, construction, or for other reasons. The content management system 110 (FIG. 1) may take these changes into consideration when determining the distance threshold. For example, the content management system 110 can determine a distance threshold “as the crow flies” to ignore changes in directions to a location. As another example, the content management system 110 can take the modified driving directions (and/or the reasons for making those modifications) into account when determining the distance threshold. As an example, the content management system 110 may identify particular users that are willing to drive longer distances when traffic congestion is less relative to other times of day (e.g., rush-hour traffic versus non-rush-hour traffic). As another example, in regions that experience snow or other conditions that are inconvenient for travel, users may indicate a preference to travel different distances during different seasons. The content management system 110 can also take these seasonal considerations into account when determining a distance threshold.

A bounding region associated with the determined location of the user device is identified (310). For example, the content management system 110 (FIG. 1) can use the determined location identifiers 212 (FIG. 2) to generate a bounding region that has the location of the user device at the center of the generated bounding region.

In some implementations, the size, position, or other aspects of the identified bounding region may be based on one or more factors. In particular, the size of the bounding region may be based on for example the threshold distance for a given entity or category of entity that is associated with a selected content item. In this way, location extensions that are associated with locations that fall inside the bounding will be acceptable (i.e., within the threshold distance) and eligible for being augmented. In some implementations, information included in the request can be used to modify or otherwise define the bounding region. In a particular example, one or more terms in the request may be limiting terms, such as “furniture stores in San Jose, Calif. but not near highway 101,” where “but not near highway 101” may be used to modify the bounding region so that the bounding region does not include areas near highway 101. As another example, content items associated with the request may be used to define the bounding region. In this particular example, if a majority of content items are in a particular area within the general vicinity of the user device, the bounding region may be generated to encompass that particular area, even though the user device may not be in the center of such a bounding region.

As yet another example, the bounding region may be modified or otherwise defined based on the geography of the area of interest. If, for example, the user device is determined to be near a shore, mountain range, or other natural physical boundary, the bounding region may be restricted in the directed of the natural physical boundary so that the bounding region does not substantially encompass the natural boundary. In a particular example, if user device is determined to be near the San Francisco Bay, the bounding region may extend only marginally beyond the shore line with a majority of the bounding region encompassing the land-based geography, even though the user device may not be in the center of such a bounding region.

As yet another example, a user or user profile associated with the user device may be used to define the bound region. In this particular example, a user profile may include information about previous commercial activity, content item selection habits, or other information that can be used to identify a bounding region. If, for example, a particular user has frequented a particular geographic area nearby the determined location of the user device more often relative to geographic areas, the bounding region may be generated to correspond to the particular geographic area, even though the user device may not be in the center of such a bounding region. As yet another example, a categorization associated with the content item can be used to define the bounding region. In this particular example, certain geographic areas near the determined location of the user device may be associated with different types of businesses or other venues. For example, a particular geographic area may have a larger density of car dealerships relative to other geographic areas. As a result, the bounding region may be restricted to a particular geographic area based on the type of venue associated with the content item, even though the user device may not be in the center of such a bounding region. One or more of the above approaches for defining the bounding region based on or more aspects can be used, for example, to maximize the amount of businesses, venues, or other content sponsors—and by extension the number of content items and location identifiers associated with the content items—that are located within the bounding region.

In some implementations, identifying the bounding region also includes the steps of identifying a first bounding region, determining that no location extensions for the content item are included in the first bounding region, and identifying a second larger bounding region, based on determining that no location extensions for the content item are included in the first bounding region. After identifying the second larger bounding region, the method can include determining when one of the one or more location extensions is included in the second larger bounding region, and, when so, augmenting the content item with the one location extension. For example the content management system 110 (FIG. 1) can generate a first bounding region using techniques described elsewhere in this specification. When no locations for content items are included in this first bounding region, the content management system 110 can generate a second bounding region that is larger than the first bounding region. In a particular example, the second bounding region is forty-kilometers by forty-kilometers larger than the first bounding region. Using the larger bounding region, the content management system 110 can determine when one of the one or more location extensions is included in the second bounding region and augment the content item with the one location extension as described elsewhere in this specification.

In some implementations, determining when plural location extensions are included in the second larger bounding region can also be performed. In some implementations, when plural location extensions are located in a respective bounding region that are associated with a given content item, a selection process can be used. In some implementations, the selection process can be a random selection or pseudo-random selection. In some implementations, the selection can be based on a distance or proximity of a particular location to one or more points of interest associated with a given bounding box (such as the center of the bounding box). In some implementations when two bounding boxes are used, selection among plural available extensions in the second larger bounding box can be based on proximity to a center of the first bounding box. For example, a particular location extension that is nearest to the center point of the first bounding region may be selected.

One or more location extensions that are associated with the content item are identified (312). For example, the content management system 110 (FIG. 1) can access the content item repository 128 (FIG. 1) to identify location extensions that are associated with the identified content items. In some implementations, identifying the one or more location extensions includes identifying plural locations extensions that are included in the bounding region and selecting one of the plural regions. For example, there may be many location extensions for a type of coffee shop in a particular bounding region. If, for example, there are plural location extensions in a first of the one or more bounding regions, one of the plural location extensions can be selected randomly. If, for example, there are plural location extensions in subsequent ones of the one or more bounding regions, one of the plural location extensions can be selected based on a proximity to the center of the subsequent bounding region.

When one of the one or more location extensions is included in the bounding region and when a distance between the location extension and a current location of the user is less than the determined threshold distance is determined (314). For example the content management system 110 (FIG. 1) can compare an address or other location information that is associated with the location extension to the addresses that are included in the bounding region. When, for example, the content management system 110 determines that none of the one or more of location extensions is included in the bounding region, the content management system 110 can generate a second bounding region and perform a comparison of an address or other location information that is associated with the location extension to the addresses that are included in the second bounding region.

Use of a bounding box that is sized in accordance with a threshold distance is one example construct for determining when to augment a selected content item with location information. As discussed above, only those location extensions that are determined to be within a distance from the determined location of the user device are used to augment the content item. For example, when a bounding region is forty-kilometers in diameter (or is a forty-kilometer by forty-kilometer box), and the determined distance threshold is five kilometers, then only those location extensions identified to be within five kilometers of the determined location of the user device are considered for use in augmenting the content item.

The content item is augmented with the one location extension (316). For example, when the content management system 110 (FIG. 1) determines that one of the one or more location extensions is included in the bounding region and within the determined threshold distance, the content management system 110 can augment the content item with the one location extension. For example, the content management system 110 can add the location extension to the content item. As another example, the content management system 110 can present the location extension in a region of a graphical user interface that in proximity to the content item so that the location extension is logically associated with the content item. That is, when a user sees the location extension in proximity to the content item, the user may automatically associate the location extension with the content item.

While reference is provided above to the selection of one or more relevant business locations based using bounding regions and threshold distances, the methods and systems described do not necessarily have to use bounding regions. For example, each potential location extension that is associated with a selected content item can be evaluated to determine whether or not it is at a distance (relative to a particular mode of transportation and other factors) that is less than the threshold for a given entity or category of entities. A selection from eligible location extensions can include a selection of a location extension that is the closest to a current location of a requesting device. Other selection methods are possible. Further, while reference is made above to determining location extensions for delivery responsive to received requests, the methods and systems proposed can be used for other purposes. For example, the methods can be used as part of an evaluation of selection criteria for an existing (or proposed) campaign, where an output is provided that represents suggestions for campaign parameters or controls related to delivery of one or more content items or additional data (such as location extensions) along with respective ones of the content items. In some implementations, the methods can be used to automatically generate location extensions for a campaign with minimal input from a campaign sponsor. In some implementations, the methods can be used to make suggestions to further augment selection criteria for a campaign, e.g., based on geographic-based suggestions. These and other uses are possible.

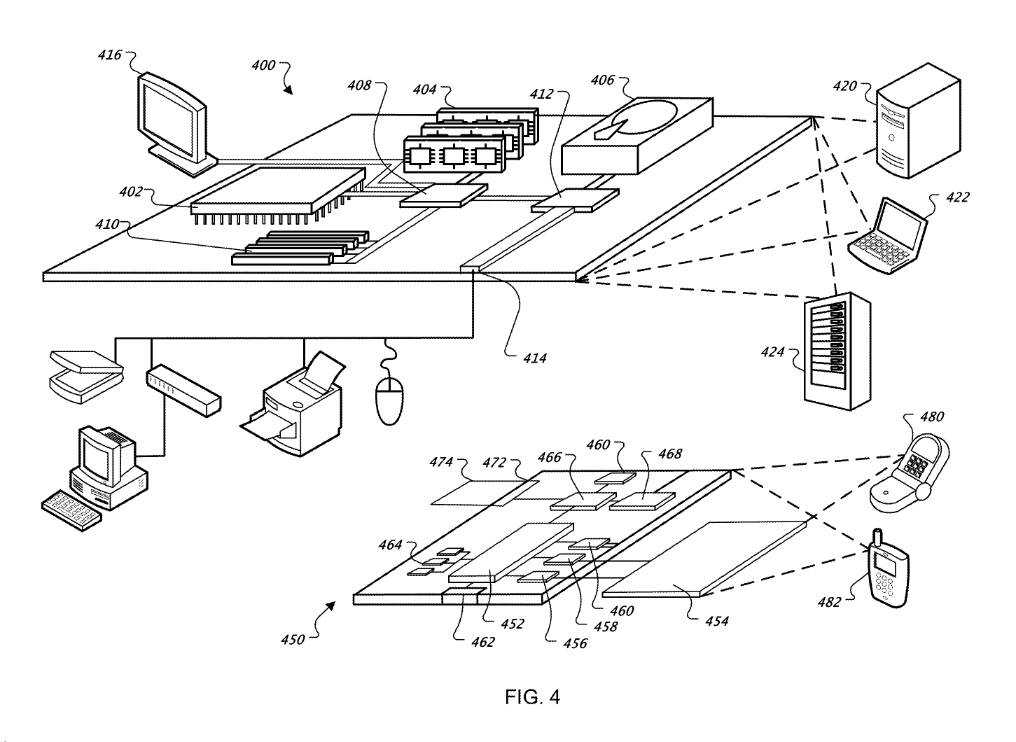

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. The computer-readable medium is not a propagating signal. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is illustrative only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communication audibly using audio codec 460, which may receive spoken information from a user and convert it to usable digital information. Audio codex 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method comprising:
receiving a request for content from a user device;
identifying, by one or more processors, a content item for delivery to the user device responsive to the request;
determining a location of the user device;
determining a threshold distance that a user is likely willing to travel when visiting a physical location associated with the content item or content sponsor;
identifying a bounding region associated with the location of the user device;
identifying one or more location extensions that are associated with the content item;
determining, by one or more processors, when one of the one or more location extensions is included in the bounding region and when a distance between the location extension and a current location of the user is less than the determined threshold distance; and
augmenting, based on the determining when the distance is less than the determined threshold distance, the content item with the one location extension.

2. The method of claim 1 wherein the request for content is associated with a search query, a map request or page request.

3. The method of claim 1 wherein the user device is a mobile device and location information for the user is provided as part of the request.

4. The method of claim 1 wherein determining the threshold distance includes evaluating requests from plural users and determining the threshold distance as a mathematical function derived from the evaluating.

5. The method of claim 4 wherein evaluating includes evaluating driving direction requests received from users that terminate at a location associated with the one location extension.

6. The method of claim 4 wherein the mathematical function is a numeric average and wherein the threshold distance represents an average distance a user would drive to visit the location.

7. The method of claim 4 wherein the threshold distance is determined based on a characterization associated with a sponsor of the content item.

8. The method of claim 7 wherein the characterization is based on a type of product or service offered by the sponsor.

9. The method claim 1 wherein identifying one or more location extensions includes identifying plural location extensions that are included in the bounding region and selecting one of the plural regions.

10. The method of claim 9 wherein the selecting is a random selection.

11. The method of claim 1 wherein augmenting includes providing the one location extension for presentation in proximity to the content item when displayed on the user device.

12. The method of claim 1 wherein identifying a bounding region includes:
identifying a first bounding region;
determining that no location extensions for the content item are included in the first bounding region;
identifying, based on determining that no location extensions for the content item are included in the first bounding region, a second larger bounding region;
determining when one of the one or more location extensions is included in the second larger bounding region; and
augmenting the content item with the one location extension.

13. A computer program product embodied in a non-transitive computer-readable medium including instructions, that when executed, cause one or more processors to:
receive a request for content from a user device;
identify a content item for delivery to the user device responsive to the request;
determine a location of the user device;
determine a threshold distance that a user is likely willing to travel when visiting a physical location associated with the content item or content sponsor;
identify a bounding region associated with the location of the user device;
identify one or more location extensions that are associated with the content item;
determine when one of the one or more location extensions is included in the bounding region and when a distance between the location extension and a current location of the user is less than the determined threshold distance; and
augment, based on the determining when the distance is less than the determined threshold distance, the content item with the one location extension.

14. The computer program product of claim 13 wherein the request for content is associated with a search query, a map request or page request.

15. The computer program product of claim 13 wherein the user device is a mobile device and location information for the user is provided as part of the request.

16. The computer program product of claim 13 wherein determining the threshold distance includes evaluating requests from plural users and determining the threshold distance as a mathematical function derived from the evaluating.

17. The computer program product of claim 16 wherein evaluating includes evaluating driving direction requests received from users that terminate at a location associated with the one location extension.

18. The computer program product of claim 16 wherein the mathematical function is a numeric average and wherein the threshold distance represents an average distance a user would drive to visit the location.

19. The computer program product of claim 16 wherein the threshold distance is determined based on a characterization associated with a sponsor of the content item.

20. A computer-implemented system comprising:
a content item engine for selecting one or more content items that are stored in a repository and that are responsive to one or more search queries or received requests;
a location identifier engine for identifying one or more location identifiers indicative of a location for a particular user device that submits a search query;
a distance threshold engine for determining a distance threshold associated with an entity or category of entities for the selected content items; and
a location extension engine for using the received content items, the received distance threshold and the received location identifiers to generate one or more augmented content items.
